(19) United States
(12) Patent Application Publication
(10) Pub. No.: US 2011/0283480 A1
(43) Pub. Date: Nov. 24, 2011

(54) LOCK WASHER AND HINGE UTILIZING THE SAME

(75) Inventor: JUNG-BIN CHANG, Tu-Cheng (TW)

(73) Assignee: HON HAI PRECISION INDUSTRY CO., LTD., Tu-Cheng (TW)

(21) Appl. No.: 12/821,330

(22) Filed: Jun. 23, 2010

(30) Foreign Application Priority Data
May 24, 2010 (TW) 99209769

(51) Int. Cl. F16B 43/02; E05D 11/10

(52) U.S. Cl. 16/333; 411/533

(57) ABSTRACT

A hinge includes a fixing member, a bolt non-rotatably fixed to the fixing member, a rotating member rotatably sleeved on the bolt, a lock washer not-rotatably sleeved on the bolt, an elastic assembly rotatably sleeved on the bolt, and a fastener fixed to a distal end of the bolt. The lock washer abuts against the rotating member. The lock washer includes a number of friction portions formed on an engaging side of the lock washer. Each friction portion includes a friction surface, and a slanting connecting surface smoothly connected to a first edge of the friction surface. A pitch is connected to a second edge of the friction surface and the connecting surface of the adjacent friction portion.

### BACKGROUND

1. Technical Field

The disclosure relates to a lock washer and a hinge utilizing the same.

2. Description of Related Art

A collapsible device, such as a notebook computer, or a clamshell mobile phone, generally includes a main body hinged to a display.

The hinge includes a fixing member attached to the display, a bolt attached to the fixing member, and a rotating member rotatably mounted to the bolt. The bolt has frictional engagement with the rotating member during rotation of the rotating member relative to the fixing member. Therefore, the display can stay positioned at any angle with respect to the main body through friction between the bolt and the rotating member. However, when opening or closing the display, the bolt and the rotating member have an initial static friction to overcome, which requires extra force to close or open the display. Occasionally too much force may be used which may cause the display to strike the main body very hard and thus damage or shorten the life of the device. Therefore, it is inconvenient for users.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a hinge, the hinge including a lock washer.

FIG. 2 is an enlarged view of the lock washer of FIG. 1.

FIG. 3 is an assembled, isometric view of the hinge of FIG. 1.

FIG. 4 is an enlarged view of the circled portion IV of FIG. 3.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

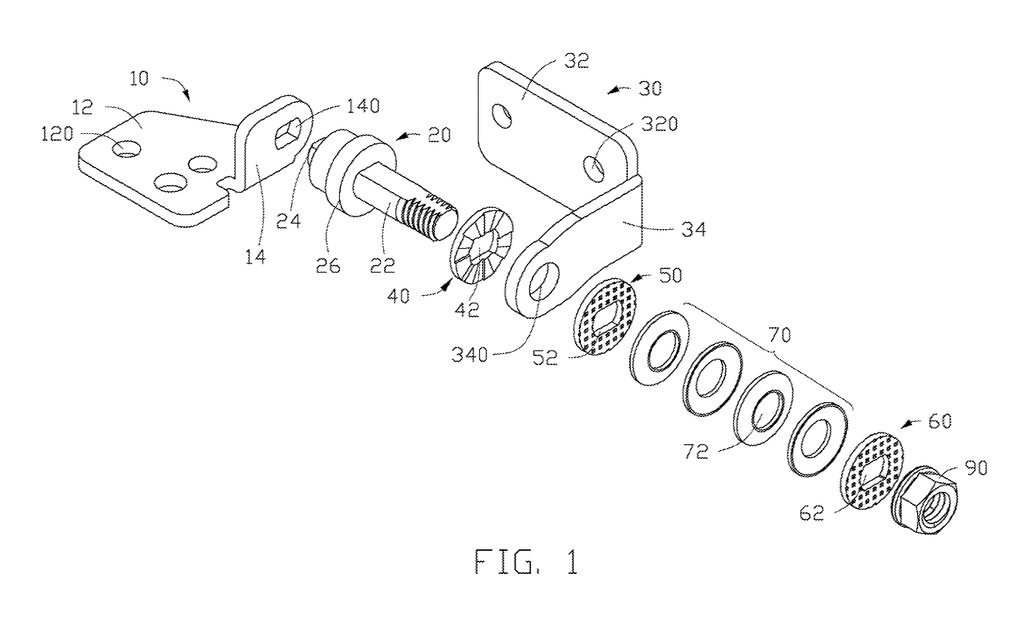

Referring to FIG. 1, in an exemplary embodiment, a hinge includes a fixing member 10, a bolt 20, a rotating member 30, a lock washer 40, a first friction washer 50, a second friction washer 60, an elastic assembly 70, and a fastener 90. In this embodiment, the fastener 90 is a nut.

The fixing member 10 includes a connecting board 12 defining a plurality of fixing holes 120 therein, and a fixing board 14 substantially perpendicularly extending from a side of the connecting board 12. The fixing board 14 defines a fixing hole 140 having a double-D shaped cross-section.

The bolt 20 includes a fixing portion 24 on the head of the bolt 20, a bolt shaft 22 opposite to the fixing portion 24, and a washer-shaped shoulder 26 between the fixing portion 24 and the bolt shaft 22. The bolt shaft 22 has a double D-shaped cross-section, and defines a threaded portion (not labeled) on the circumference of a distal end of the bolt shaft 22, for engagement with the fastener 90. The shoulder 26 has a greater diameter than the bolt shaft 22.

The rotating member 30 is substantially L-shaped. The rotating member 30 includes a fixing arm 32 defining a plurality of fixing holes 320 therein, and a pivoting portion 34 extending from an end of the fixing arm 32. The pivoting portion 34 defines a through hole 340, through which the bolt shaft 22 of the bolt 20 rotatably extends.

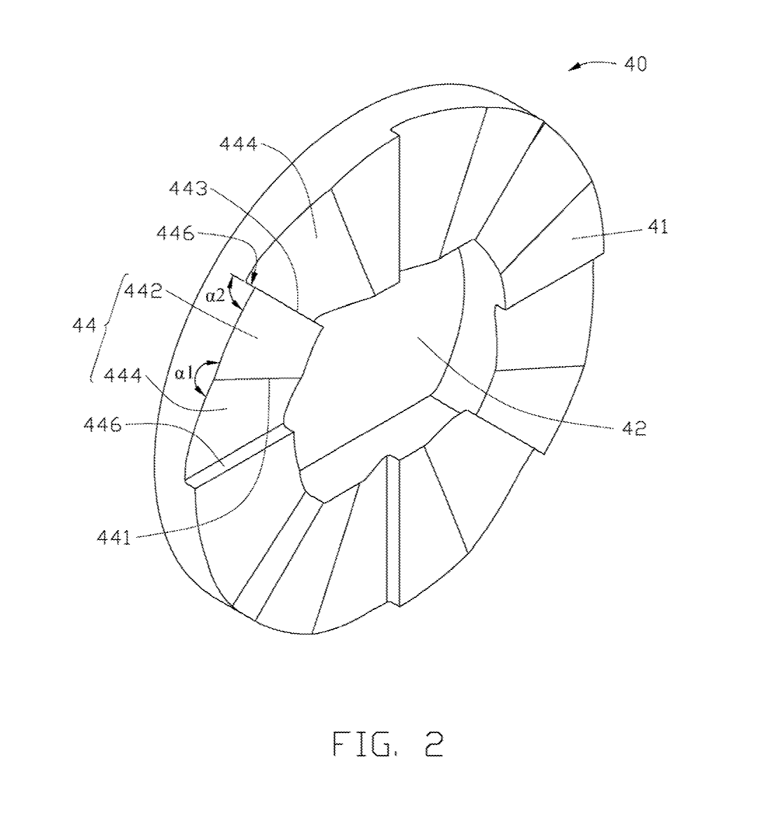

Referring to FIG. 2, the lock washer 40 defines a double-D shaped matching hole 42 in a center of the lock washer 40, through which the bolt shaft 22 of the bolt 20 non-rotatably extends. The lock washer 40 has a wavy engaging side 41 facing the pivoting portion 34 of the rotating member 30. A plurality of friction portions 44 are formed on the engaging side 41, around the matching hole 42, and extending towards a circumference of the lock washer 40. Each friction portion 44 includes a raised friction surface 442 substantially parallel to a side surface of the pivoting portion 34 of the rotating member 30. A slanting connecting surface 444 smoothly extends from a first edge 441 of the friction surface 442 to form a pitch 446 that connects to a second edge 443 of an adjacent friction surface 442. Therefore, the pitch 446 is formed between each friction surface 442 and an adjacent connecting surface 444 connected to the second edge 443 of the friction surface 442. A first angle α1 is formed between each friction surface 442 and the connecting surface 44 connected to the first edge 441 of the friction surface 442. A second angle α2 is formed between each friction surface 442 and the pitch 446, and the first angle α1 is larger than the second angle α2. In this embodiment, the first angle α1 is an obtuse angle, and the second angle α2 is an acute angle or a right angle.

The first friction washer 50 defines a double-D shaped fixing hole 52, through which the bolt post 22 of the bolt 20 non-rotatably extends. The second friction washer 60 is similar to the first friction washer 50. Similarly, the second friction washer 60 defines a double-D shaped fixing hole 62, through which the bolt post 22 of the bolt 20 non-rotatably extends.

The elastic assembly 70 includes a plurality of elastic rings (not labeled) arranged in a line and resisting against each other. Each elastic ring defines a round through hole 72, allowing the bolt post 22 of the bolt 20 to rotatably extend through. The elastic assembly 70 provides elasticity along an axis of the bolt 20, to tighten the lock washer 40, the first and second friction washers 50 and 60, and the rotating member 30.

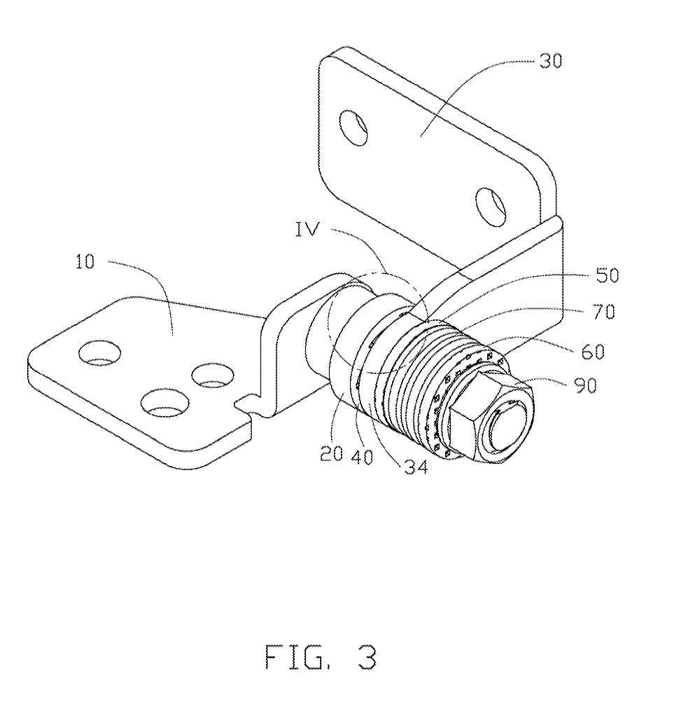

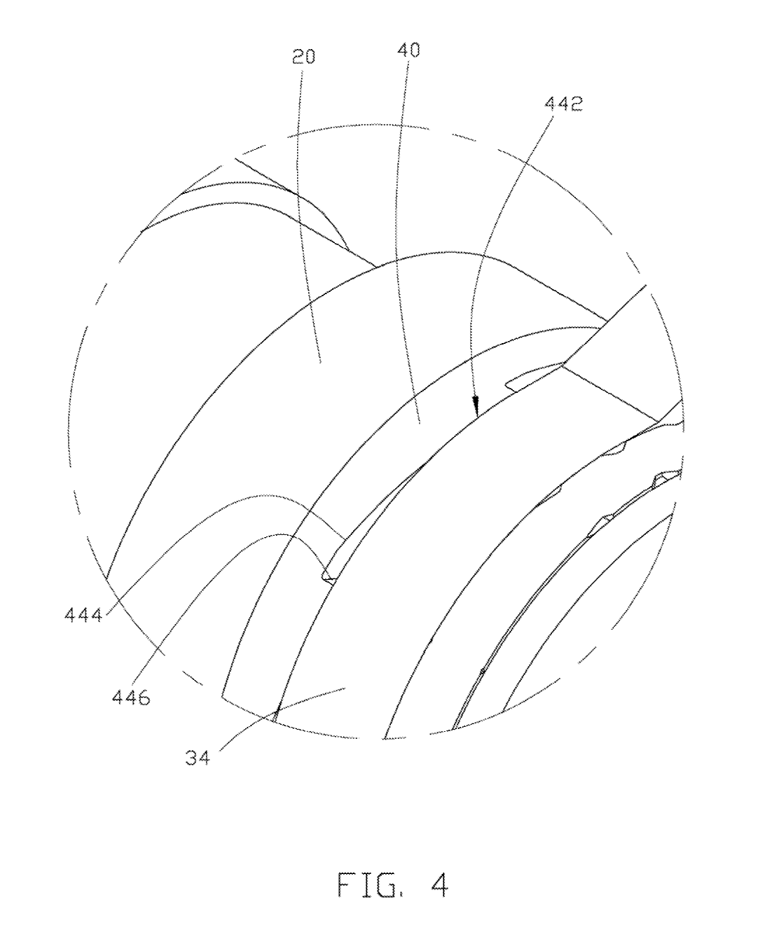

Referring to FIGS. 3 and 4, in assembly, the fixing portion 24 of the bolt 20 is inserted into the fixing hole 140 of the fixing member 10. Thereby, the bolt 20 is non-rotatably fixed to the fixing member 10, with the shoulder 26 of the bolt 20 abutting against the fixing board 14 of the fixing member 10. The bolt post 22 of the bolt 20 is extended through the matching hole 42 of the lock washer 40, the through hole 340 of the rotating member 30, the fixing hole 52 of the first friction washer 50, the through hole 72 of the elastic assembly 70, and the fixing hole 62 of the second friction washer 60 in succession, with the distal end of the bolt shaft 22 engaging in the fastener 90. This prevents the rotating member 30, the lock washer 40, the first and second friction washers 50 and 60, and the elastic assembly 70 from disengaging from the bolt 20. In this state, the friction surfaces 442 of the lock washer 40 abut against the side surface of the pivoting portion 34.

In use, the above-mentioned hinge can be utilized in a collapsible device (not shown), such as a notebook computer, that includes a base (not shown) and a cover (not shown) hinged to the base. The rotating member 30 is fixed to the cover through the fixing holes 320. Correspondingly, the fixing member 10 is fixed to the base through the fixing holes 120. While opening the cover, the cover is rotated relative to the base, with the rotating member 30 rotated towards the second edge 443 of each friction surface 442 of the lock washer 40 relative to the fixing member 10. In this process, the friction preventing the rotating member 30 from rotating is low, because the first angle α1 is an obtuse angle to lead the connecting surface 444 to smoothly connect to the friction surface 442. Therefore, the rotating member 30 is easy to rotate, so that the cover is easily to open.

When the cover is closed towards the base, the rotating member 30 is rotated towards the first edge 441 of each friction surface 442 of the lock washer 40 relative to the fixing member 10. In this process, the friction preventing the rotating member 30 from rotating is high, because the second angle α2 is an acute or right angle. Therefore, the rotating member 30 is rotated slowly, to prevent the cover from failing fast to strike the base.

In another embodiment, the hinge can include two lock washers 40 located at opposite side surfaces of the pivoting portion 34 of the rotating member 30.

It is believed that the present embodiments and their advantages will be understood from the foregoing description, and they will be apparent that various changes may be made thereto without departing from the spirit and scope of the description or sacrificing all of their material advantages, the examples hereinbefore described merely being exemplary embodiment.

What is claimed is:

1. A hinge comprising:
a fixing member;
a bolt non-rotatably fixed to the fixing member, the bolt comprising a bolt shaft;
a rotating member rotatably sleeved on the bolt shaft;
a lock washer not-rotatably sleeved on the bolt shaft, and abutting against the rotating member, the lock washer comprising a plurality of friction portions formed on an engaging side of the lock washer facing the rotating member, each friction portion comprising a friction surface, and a slanting connecting surface smoothly connected to a first edge of the friction surface, a pitch connected to a second edge of the friction surface and the connecting surface of an adjacent friction portion; and
an elastic assembly rotatably sleeved on the bolt shaft, to provide elasticity along an axis of the bolt shaft to tighten the lock washer and the rotating member; and
a fastener fixed to a distal end of the bolt shaft.

2. The hinge of claim 1, wherein the bolt shaft has a double D-shaped cross-section, the lock washer defines a double-D shaped matching hole, through which the bolt shaft extends.

3. The hinge of claim 2, wherein the engaging side of the lock washer is wave-shaped, and the friction portions are around the matching hole, the rotating member comprises a pivoting member, the fiction surfaces abut against the pivoting member.

4. The hinge of claim 3, wherein the pivoting member defines a through hole, through which the bolt shaft extends.

5. The hinge of claim 1, wherein a first angle is formed between each friction surface and the adjacent connecting surface connected to the first edge of the friction surface, a second angle is formed between each friction surface and the corresponding pitch, the first angle is larger than the second angle.

6. The hinge of claim 5, wherein the first angle is an obtuse angle, and the second angle is an acute angle or a right angle.

7. A lock washer defining a matching hole in a center of the lock washer, the lock washer comprising:
a wave-shaped engaging side, a plurality of friction portions formed on the engaging side, around the matching hole; each friction portion comprising a friction surface, a slanting connecting surface smoothly connected to a first edge of the friction surface, and a pitch connected to a second edge of the friction surface;
wherein the pitch is formed between each friction surface and the connecting surface of an adjacent friction portion.

8. The lock washer of claim 7, wherein a first angle is formed between each friction surface and the adjacent connecting surface connected to the first edge of the friction surface, a second angle is formed between each friction surface and the corresponding pitch, the first angle is larger than the second angle.

9. The lock washer of claim 8, wherein the first angle is an obtuse angle, and the second angle is an acute angle or a right angle.

10. A lock washer defining a matching hole in a center of the lock washer, the lock washer comprising:
a wave-shaped engaging side, a plurality of friction portions formed on the engaging side, around the matching hole; each friction portion comprising a friction surface, a slanting connecting surface connected to a first edge of the friction surface, and a pitch connected to a second edge of the friction surface;
wherein a first angle is formed between each friction surface and the adjacent connecting surface connected to the first edge of the friction surface, a second angle is formed between each friction surface and the corresponding pitch, the first angle is larger than the second angle.

11. The lock washer of claim 10, wherein the first angle is an obtuse angle, and the second angle is an acute angle or a right angle.
